(19) United States
(12) Patent Application Publication
(10) Pub. No.: US 2005/0278255 A1
(43) Pub. Date: Dec. 15, 2005

(54) Transaction data exchange system and approach

(76) Inventors: Dean W. Hahn-Carlson, Lilydale, MN (US); William W. Sather, Oakdale, MN (US); David A. Suits, Robbinsdale, MN (US)

Correspondence Address: Crawford Maunu PLLC, Suite 390, 1270 Northland Drive, St. Paul, MN, 55120, US

(21) Appl. No.: 11/120,629

(22) Filed: May 3, 2005

Related U.S. Application Data
(60) Provisional application No. 60/578,376, filed on Jun. 9, 2004.
(60) Provisional application No. 60/578,244, filed on Jun. 9, 2004.

(51) Int. Cl. G06F 17/60

(52) U.S. Cl. 705/52

(57) ABSTRACT

Transaction processing is facilitated using an approach involving the provision of extracted data to transaction parties. According to an example embodiment of the present invention, transaction information is provided to parties to the transaction as a function of rules relating to the transaction. The rules can be used to assign accounting codes (e.g., any correlation that can be used to identify a transaction or transaction component), which are in turn used to identify information that is to be provided to one or more transaction parties.

### RELATED PATENT DOCUMENTS

This patent document claims priority under 35 U.S.C. §119 to U.S. Provisional Patent Application Nos. 60/578,376 and 60/578,244, respectively entitled “Transaction Data Exchange System and Approach” and “Automated Transaction Processing System and Approach,” both of which were filed on Jun. 9, 2004.

### FIELD OF THE INVENTION

The present invention is directed to transactions and, more specifically, to the processing and management of transactions involving the processing of interactions involving goods and/or services.

### BACKGROUND

Transaction processing has typically involved intensive manual effort and, in instances where automatic processing has been used, intensive user intervention. For example, many transaction processes involve the use of a variety of transaction documents (electronic and/or paper) such as orders, invoices, receipts and bills of lading (BOL). These types of transaction documents include information associated with the transaction that is used by parties to the transaction to monitor and process the transaction.

Transaction documents are electronically processed for a multitude of different types of business applications. Transaction interaction data, (e.g., electronic or physical documents) describing characteristics of a particular transaction interaction is often encountered in varied temporal order at central transaction locations that assemble these documents into logical packages for automated processing. For example, when an interaction involves the sale of a product from a seller to a buyer, there are often multiple parties to the transaction in addition to the buyer and seller, such as shippers, financial institutions, distributors and regulatory agencies (e.g., customs, taxation agencies). Each of these parties often provides one or more different types of documents that relate to the transaction. Often, the documents are not in a format that is readily discernible relative to documents from other parties, requiring extensive effort to organize the documents into categories or transactions. In addition, different parties to the transaction often desire to obtain different types of transaction information, or similar transaction information but in different formats, requiring significant effort to extract the proper information and to place the extracted information in proper format.

A variety of transactions are particularly susceptible to processing difficulties such as those relating to the processing and presentation of data for use by parties to a transaction. For example, pre-payment reconciliation and auditing for a particular transaction are often automatically carried out electronically at a central processor. However, data relating to these functions and others is often difficult to extract from the central processor for use by parties to the transaction. In addition, previously-available approaches to the provision of transaction-based information to parties to the transaction do not facilitate interaction with the central processor for interactively configuring the type of data being extracted and presented to the party.

Another type of incompatibility that has made transaction processing difficult is related to the common scenario wherein reference numbers used by different parties to identify a particular transaction are not compatible. For example, in transactions involving buyers and sellers, sellers maintain transaction data organized by reference numbers generated by the seller. Buyers typically must access the data using a seller's reference number rather than the buyer's reference number. In addition, buyers and sellers typically use different reference numbers for different characteristics of the transaction, making the monitoring and management of the transaction difficult.

As more and more documents are required to fully articulate business interactions, this problem of managing documents and other interaction data and, in particular, of extracting information from the documents and/or from processes using data from the documents becomes increasingly challenging. Manual parsing and categorization of these documents and associated extraction of data therefrom is expensive, time consuming and susceptible to error. Previously available automated approaches are generally limited in applicability to certain types of documents or certain inflexible methods of document identification and categorization.

Payment and billing related aspects of traditional transactions are particularly susceptible to billing errors and fraud. For example, there often is little to no connection between the delivery of goods and the billing for the delivery and/or the goods. This may result in double billing, no billing at all, or over billing. Auditing errors that cause incorrect billing or payment may also occur. In addition, payment can often be delayed while aspects of a particular transaction are being audited and/or disputed, particularly when different transaction documents must be manually parsed and processed. For example, documents from different parties to a transaction must often be parsed and compared to relate data from one document to another in a manner that will facilitate billing. Delay associated with billing reduces working capital resources for parties to the transaction waiting for payment. Monitoring and management of payment and billing related transaction aspects helps to address some of these issues; however, extracting information in a controlled manner to facilitate this type of monitoring and management has been generally difficult.

Additional costs arise as a result of existing inefficiencies in a variety of transaction-processing approaches. Many of the costs are individually small, but very large in the aggregate. For example, typical parties to transactions incur administrative costs including those relating to the costs for creating and delivering transaction documents, resolving billing disputes, providing documents and other data to other parties and posting accounts receivable. In addition, the cost of parsing, extracting information from and formatting documents related to these and other items adds to the administrative costs of transactions.

An additional challenge to transaction management involves the inability to obtain immediate, or even timely, transaction information. Transaction data from one party is typically not readily available to other parties to the transaction without direct access to private-party systems. Since the process is largely conducted manually, it is very difficult to track a transaction and real-time data is particularly difficult to come by. For example, there are various manual steps involved in order to learn of the status of shipment or payment. If a shipper wants to know if a carrier delivered the goods for a particular transaction and if the payment has been made, the shipper often must contact the carrier and/or the appropriate financial institution.

The above and other difficulties in the management and coordination of transactions have presented challenges to the effective and efficient management of transactions.

### SUMMARY

The present invention is directed to overcoming the above-mentioned challenges and others related to the types of approaches and implementations discussed above and in other applications. The present invention is exemplified in a number of implementations and applications, some of which are summarized below.

According to an example embodiment of the present invention, transaction interactions are managed using an approach involving the use of transaction data based rules for providing information to transaction parties. The generation and dissemination of party-specific information is thus implemented and controlled on a user-specific level and, where appropriate, implemented in an environment involving the processing of a plurality of transactions involving a plurality of different transaction parties.

In connection with another example embodiment of the present invention, party-specific data is generated and sent to the specific party as a function of user profile information specifying a type of transaction data, a timing characteristic identifying a time at which to generate the specified type of transaction data, a location to which the generated transaction data is to be sent and a protocol via which the generated transaction data is to be sent. This approach is implemented, for example, with a transaction processing system for processing transaction data for transactions involving merchant offerings among transaction parties. Further, this approach can be implemented using one or more of a variety of systems and arrangements, including those discussed and shown herein as well as others. In addition, where data fields in different locations are related, such as wherein a payment field for a particular transaction affects a transaction party's accounts payable field, the related data fields can be accordingly updated via the generation of the party-specific data.

In another example embodiment of the present invention, a transaction-processing system processes transaction data for transactions involving merchant offerings among transaction parties, implementing user profile information for transaction parties including information for associating transaction data with a transaction party and for generating and controlling access to party-specific data. The system (e.g., implementing a computer processing arrangement) associates transaction data with the particular party as a function of the transaction data and user profile information for the particular party. For example, data in the transaction party may identify an identification associated with the particular party, or with a transaction in which the party is a participant. The system generates party-specific data from the transaction data as a function of the particular party's user profile information, and provides access to the generated party-specific data to the particular party as a function of the user profile information.

The party-specific data is generated in accordance with a particular user's preferences, such as those including information specifying one or more of: what data to generate, when to generate the data, how to arrange the data, what type of configuration to place the data in and a protocol to use in communicating the data. In this regard, a particular user can direct system-specific data generation at specified times to facilitate its transaction processing, with the transaction-processing system carrying out such functions on behalf of a plurality of users, each user specifying its personalized functions. Furthermore, the transaction processor can assess a fee for the data generation and/or processing performed for the user, and assess the fee in one or more of a variety of manners, on a user-specific basis.

In a more particular example embodiment of the present invention, a transaction-processing system is adapted for processing accounting data for transactions involving merchant offerings among remote parties including buyers and sellers, and for providing accounting data to one or more transaction parties. The system includes a transaction databank adapted to store user profile information for parties to a transaction. The user profile information includes information for associating transaction data with parties to the transaction and for applying party-specific accounting codes to the transaction data. A central computer arrangement is adapted, for at least one party to a particular transaction, to assign accounting codes to financial data for the particular transaction as a function of the user profile information for the at least one party. Data is automatically generated for the at least one party as a function of the assigned accounting codes and the user profile information for the at least one party. The central computer arrangement further provides access to the automatically generated data to the at least one party.

The above summary of the present invention is not intended to describe each illustrated embodiment or every implementation of the present invention. The figures and detailed description that follow more particularly exemplify these embodiments.

### BRIEF DESCRIPTION OF THE DRAWINGS

The invention may be more completely understood in consideration of the detailed description of various embodiments of the invention in connection with the accompanying drawings, in which:

FIG. 1 is a flow diagram showing an approach for transaction management involving the generation of update data for accounting-type fields, according to an example embodiment of the present invention;

FIG. 2 shows a transaction processing arrangement, according to another example embodiment of the present invention; and

FIG. 3 is a flow diagram showing an arrangement 300 and corresponding approach to managing data exchange in connection with transactions and related data management, according to another example embodiment of the present invention.

While the invention is amenable to various modifications and alternative forms, specifics thereof have been shown by way of example in the drawings and will be described in detail. It should be understood, however, that the intention is not necessarily to limit the invention to the particular embodiments described. On the contrary, the intention is to cover all modifications, equivalents, and alternatives falling within the spirit and scope of the invention as defined by the appended claims.

### DETAILED DESCRIPTION

The present invention is believed to be applicable to a variety of different types of transaction approaches and interactions, and has been found to be particularly useful for applications involving the processing of transactions, management of data corresponding to the transactions and related aspects thereof. While the present invention is not necessarily limited to such approaches, various aspects of the invention may be appreciated through a discussion of various examples using these and other contexts.

According to an example embodiment of the present invention, an automatic transaction information presentation and update approach involves the automatic processing of transactions between two or more transaction parties, and automatic generation of transaction-related data. Stored party profile information is used to identify transactions in which a particular party is involved. When transaction data is updated, the party profile information is used to automatically update transaction characteristics that are related to the updated data. In some instances, the update involves passing updated transaction data for storage in related data fields. In other instances, the update involves generating different data that is used to update the related data fields. In still other instances, the update involves the generation of control type signals that are used to alert a transaction party of updated transaction data and, in certain applications, provide the transaction party with the updated transaction data.

In another example embodiment of the present invention, a transaction processor is responsive to data-related events for automatically generating and communicating update information that relates to the events. When a data-related event such as a change in data or a scheduled status check occurs for a particular transaction, the transaction processor identifies parties that are related to the transaction as a function of party profile information. The transaction processor further automatically generates update information in accordance with the party profile information for the related parties, and communicates the update information to identified parties. In some instances, the transaction processor generates update information in a manner that is specific to a particular party's profile information. In other instances, the transaction processor generates update information that is generally intended for more than one specific transaction party.

The transaction processor is responsive to a variety of different types of data-related events, such as those involving changes (or lack of change) in the data, automated data events and cyclic data events, as well as status checking events. The transaction processor is configured to monitor data and/or transactions for selected data events as a function of user profiles. The monitoring may involve a passive response to a change in data, active monitoring and/or triggered monitoring, wherein the transaction processor monitors data in response to trigger event information such as a cyclic trigger or a trigger that is responsive to a certain condition.

In some instances, user profiles for transaction parties may be used to specify trigger events (i.e., that trigger status checks or transaction events), file types to use, file destinations for users and other information useful in the automatic generation and communication of transaction data-related information. For example, user profile information may be implemented to indicate that the particular user (to which the profile information belongs) wishes to be notified of updates that affect that user's General Ledger. In this regard, the transaction processor automatically identifies data conditions that would affect the user's General Ledger and generates update information regarding the data conditions. In one implementation, the transaction processor automatically updates information in the user's General Ledger with the generated update information.

In another example embodiment of the present invention, a user interface is configured to enable a transaction party to manage its own configuration and control structures for processing and reporting data as discussed above. This approach may be implemented, for example, with one or more of the above-discussed processing approaches, with user access enabled for controlling data processing and reporting. Access to the management of configuration and control structures is restricted to transaction parties (users) having authorization, using security type control measures such as passwords and encryption to manage access to configuration and control data.

In one instance, inputs received at the user interface are stored and used to extract selected accounting data at appropriate levels of aggregation. The transaction processor is responsive to the user inputs by extracting the selected accounting data and, where appropriate, reporting or otherwise processing the selected data. The user inputs are stored in a location accessible by the transaction processor (or processors) effecting the data processing and reporting. For example, where access to a database at the user interface is granted to such the transaction processor, the inputs can be stored in the database at the user interface. The user inputs may also (or in the alternative) be passed directly to a database that is locally accessible to the transaction processor, alleviating any necessity of longer-distance communications.

In some implementations, the transaction update data is formatted at the direction of a party to the transaction (e.g., as indicated in party profile information). The update data may be formatted, for example, in a manner that is acceptable by the General Ledger system of the user requesting the extracted data. In some instances, the above-discussed transaction processor formats the data and communicates data for updating related transaction data fields. Information used to reformat the update data can be stored in user profiles, with the transaction processor formatting the extracted data as a function of the data in the profile of the user to which the data is being sent.

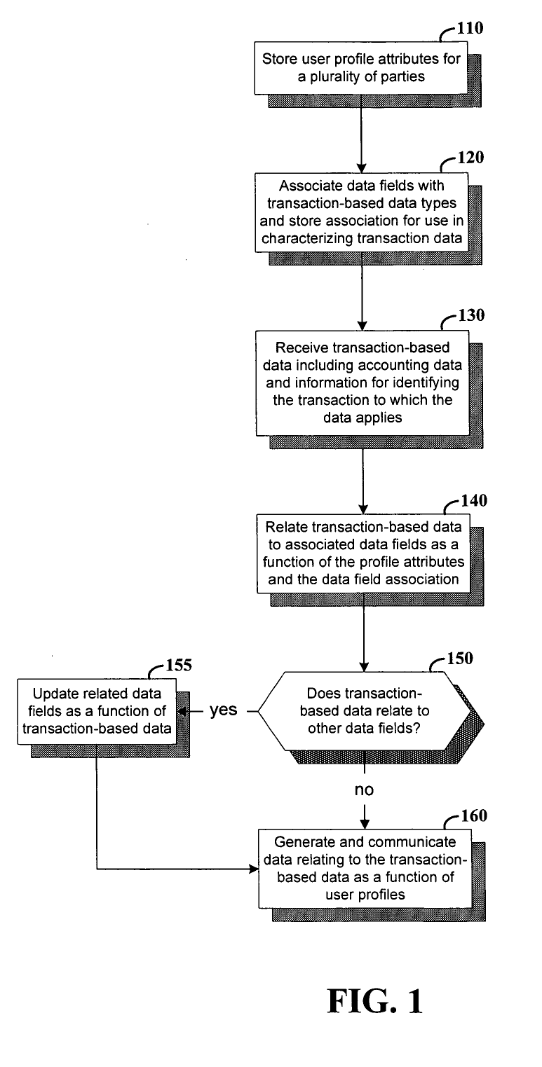

FIG. 1 is a flow diagram showing an approach for transaction management involving the generation of update data for accounting-type fields, according to another example embodiment of the present invention. At block 110, user profile attributes are stored for a plurality of transaction parties. The user profile attributes include a variety of types of data related to a particular user, such as a buyer or a seller for a particular transaction, a third party facilitating the transaction or other parties having an interest in the transaction, depending upon the implementation. For example, as a starting point, identification and accounting processing data can be stored for the particular user to which the profile attributes belong. Additional data relating to user preferences, business rules, security information and more can also be stored in the user profile attributes. Business rules may include, for example, rules for updating related accounting fields, transaction processing rules, data communication rules and others.

At block 120, data fields are associated with transaction-based data types and the association is stored for use in characterizing transaction data. For example, where a particular type of transaction-based data type involves an expense that affects an accounts payable data field, the expense is associated with an accounts payable data field. In this regard, when such an expense is incurred, it affects the associated accounts payable data field as indicated in the association at block 120.

Transaction-based data, including accounting data and information for identifying the transaction to which the accounting data applies, is received at block 130. The transaction information may include, for example, data that identifies a particular transaction using a reference number, or other identifying information pertaining specifically to that transaction. Other identifying approaches may involve the identification of parties to the transaction, together with the use of other information that, together with the party-identifying information, is used to identify the transaction.

At block 140, the transaction-based data is related to associated data fields as a function of the user profile attributes stored at block 110 and the association at block 120. In one implementation, the relation of transaction-based data to associated data fields involves matching the transaction-based data with parties to the transaction based on the user profile attributes. In another implementation, the relation of transaction-based data to associated data fields involves matching the transaction-identifying data to accounting fields that are identified as belong to the identified transaction.

If the transaction-based data received at block 130 relates to other data fields (e.g., as associated at block 120) at block 150, related data fields are updated as a function of transaction-based data at block 155, the transaction-based data being that received at block 130 and/or previously available (e.g., to a transaction processor facilitating data exchange). For instance, using the above example, where transaction-based data affects a particular company's accounts payable data field, that accounts payable data field is updated at block 155. A variety of data fields related at block 140 can be updated in this manner, such as a particular user's data fields or data fields that are assigned to a particular transaction (and applicable to any transaction party).

After a related data field or fields are updated at block 155, or if the transaction-based data doesn't relate to other fields at block 150, data is generated and communicated as a function of the user profiles at block 160. The communication may involve, for example, sending transaction information or making the transaction information available for access, relative to new transaction-based data received at block 130 or, in some applications, relative to general data reporting for a particular transaction party.

In some instances, the transaction-based data is formatted at block 160 to be made available as a function of the user profile attributes for implementation with a particular user's accounting system. For example, where a user wishes to receive update data including information that can be recognized by that user's accounting software, the user can store, in its user profile, information for formatting the update data. The formatting may involve, for example, the association of field-identifying information with the update data such that accounting software can easily identify accounting fields to be updated.

In some applications, the update carried out at block 155 is implemented in connection with the generation and communication at block 160. For instance, where the transaction-based data relates to other fields at block 150, the update of related data fields at block 155 involves generating and communicating update data as a function of user profiles. The communicated update data is used to update related data fields, e.g., at a remote user's accounting system. Further, where a certain format is required by the remote user's accounting system, the formatting is carried out at block 160 as discussed above, such that the communicated data is usable by the remote user's accounting system to carry out updates to relevant data fields.

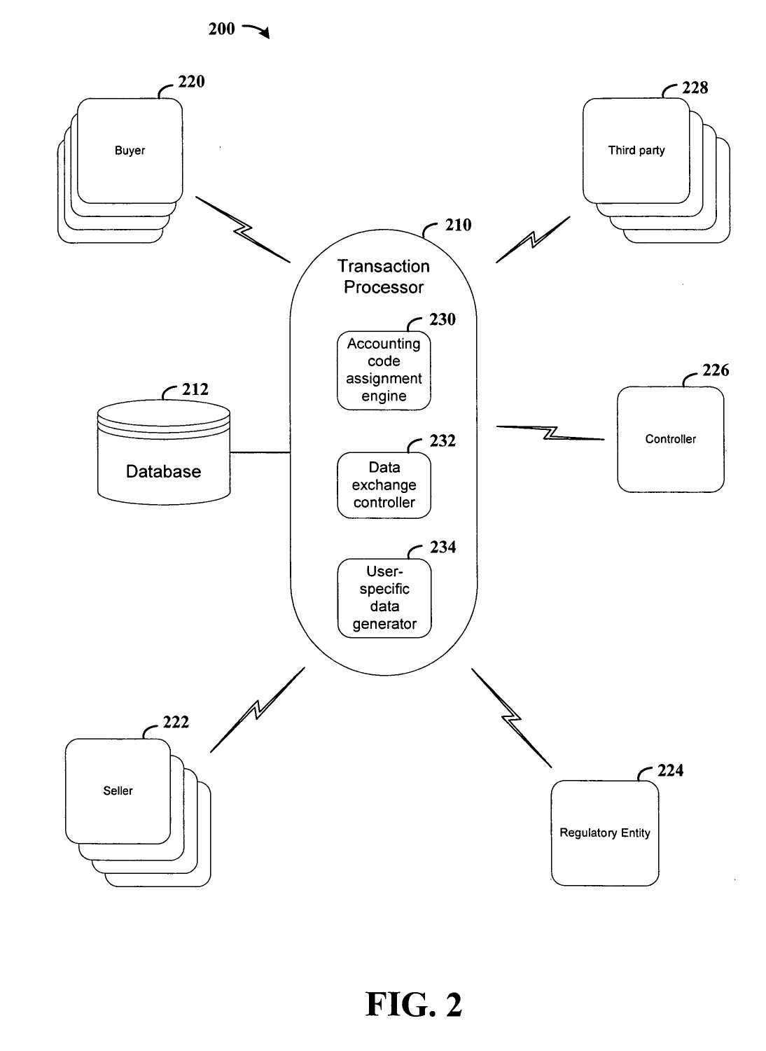

FIG. 2 shows a transaction processing arrangement 200, according to another example embodiment of the present invention. A transaction processor 210 is adapted to interface with a database 212 for processing transaction information and for generating outbound data for communication to external users and, in some applications, for updating transaction-related fields as a function of transaction conditions. A plurality of user nodes 220-228 (e.g., transaction party nodes) communicate with the transaction processor 210 for a variety of transaction-related purposes, with the transaction processor providing the outbound data for at least one of the user nodes. For illustrative purposes, user node 220 is indicated as a buyer, node 222 as a seller, node 224 as a regulatory entity, node 226 as a controller and node 228 as a third party involved in a transaction or transactions involving other parties. The buyer and seller nodes are generally implemented with buyers and sellers who are parties to transactions processed by the transaction processor 210. The controller 226 generally controls the transaction processor 210, engaging in contractual type relationships with the buyers and/or sellers (or other transaction parties) and assessing a fee associated with the processing functions carried out on behalf of these transaction parties. The regulatory entity 224 may involve one or more regulatory entities, depending upon the application, such as those implemented for monitoring sensitive financial transfers, for assessing taxes, for ensuring proper international-based transaction processes (i.e., for clearing customs) or for ensuring compliance with regulations such as those associated with acts such as the Sarbanes-Oxley act of 2002. Furthermore, these nodes 220-228 may involve two or more of each type of entity involved as entity types shown with each node, and in particular, as shown with multiple potential buyers, sellers and third parties respectively at nodes 220, 222 and 228.

The transaction processor 210 is adapted to receive and process transaction-profile information for a multitude of transactions and to generate outbound data as a function of the transaction-profile information. Transaction-profile information is stored in the database 212 for use by the transaction processor 210 in generating outbound data. The transaction-profile information generally includes rules and/or other information useful in processing transactions, including information (e.g., accounting codes) for associating transaction data with related transaction fields for updating different fields that relate to one another. When transaction-profile information indicates that a particular field is related to another field, updates to the particular field are processed to accordingly update the other field.

In some instances, the transaction profile information stored at the database 212 includes general information that can be used in connection with more than one transaction. In other instances, the transaction profile information includes information that is specific to a particular transaction or to a particular category of transactions. Specific transaction categories may be defined, for example, as a function of a party to the transaction or as a function of the type of the transaction. In addition, the transaction-profile information may include information used by the transaction processor 210 for defining the transaction categories.

The transaction processor 210 generates the outbound data in a variety of manners and for a variety of purposes, depending upon the implementation. For instance, when transaction information is received at the transaction processor 210 from one of the user nodes 220-228 (e.g., processors), the transaction processor checks the database 212 for information relating to the received transaction information. If matching information is found, the transaction processor 210 links the received transaction information to another user node and generates outbound data for the other user node.

As an example, when a buyer at node 220 contracts with a seller at node 222 for a transaction involving a carrier at node 228, transaction profile information linking these users to the transaction is stored at the database 212. When one of the three nodes 220, 222 and 228 generates update information and passes that information to the transaction processor 210, the transaction processor correlates the update information to other users via the transaction profile information.

If the update information matches data at another one of the user nodes, the transaction processor 210 generates and sends outbound data to that node. For example, if a carrier at node 228 sends data to the transaction processor 210 indicating that a shipment has been completed, the transaction processor 210 uses that information to generated update information. The (outbound) update information is sent to each of the buyer node 220 and seller node 222 for updating data fields that relate to shipment status. In this regard, a multitude of different transaction data types can be updated between buyers, sellers, carriers, financial institutions and more using approaches similar to this approach with a buyer, seller and carrier.

The transaction processor 210 is programmed to carry out the above-discussed transaction functions relative to data exchange (e.g., the transmission of data), as well as others for a variety of transaction functions, depending upon the implementation. In some applications, the transaction processor 210 employs particular applications (e.g., programmed software-based and/or hardware-based applications) to carry out these and other functions. For example, applications shown in FIG. 2 include an accounting code assignment engine 230, a data exchange controller 232 and a user-specific data generator 234. These applications are selectively implemented with the above approaches and others, with additional examples described below.

The accounting code assignment engine 230 is implemented where transaction data relates to accounting-type information, such as data typically included with invoices, receipts, orders, shipping documents and others. For instance, where a transaction document is received and identifies that a payment has been made for a particular transaction, the accounting code assignment engine 230 associates the payment as an expense and assigns an accounting code to correspond to the particular type of expense. Other accounting code information relates particular transaction data fields to other data fields, such as by relating several expense fields to an accounts payable field, where an update relating to a paid expense is accordingly assigned an accounting code that relates the paid expense to an accounts payable field identifying accounts payables for several expenses.

The accounting code assignment engine 232 assigns accounting codes relative to profile information stored in the database 212 and parties to the transaction. For example, where a particular transaction party identifies accounting codes to be assigned to different types of accounting data such as expenses, payables, receivables and more, that user provides the codes to the transaction processor 210 for storage in the database 212 together with profile information for that user. When a transaction document (e.g., an electronic document or other data) is received at the transaction processor 210, the transaction processor associates the document with profile information stored in the database 212 and implements the accounting code assignment engine 230 to assign accounting codes as indicated in the associated profile information.

The data exchange controller 232 is implemented to control the exchange of data with external entities, such as those shown in FIG. 2. In some applications, the data exchange controller is implemented to control the exchange of data among different data storage locations accessible by the transaction processor 210. One example type of data exchange involves the provision of data to a regulatory entity 224, such as for customs, tax, compliance or other functions. Another example type of data exchange involves the exchange of data with transaction parties for implementation in their accounting structures. In some applications, the data exchange controller 232 exchanges data that has been generated on a user-specific basis, with applications involving user-specific data generation discussed below in connection with the user-specific data generator 234.

The user-specific data generator 234 uses information stored in the database 212 in association with profile information for specific users to generate data tailored to specific users. In some applications, the user-specific data generator 234 uses profile information for a particular user that specifies trigger events, such as a cyclic event or other specific event, to initiate the generation and exchange of data. For example, where a particular transaction party requests that periodic update information be delivered by the transaction processor 210 for that party's transactions, the user-specific data generator 234 uses profile information for that party to generate the update information. The data exchange controller 232 is implemented to effect the exchange of the generated update information.

Another example type of user-specific data involves data tailored to user-specific accounting processors, such as those implemented by one or more of the buyer 220, seller 222 and third party 228. For instance, where a seller 222 contracts with the controller 226 to process transactions on behalf of the seller and to generate outbound data for a General Ledger chart of accounts for the seller, information needed for performing these services is stored in the database 212 in connection with profile information for the seller 222. The transaction processor 210 implements the user-specific data generator 234 to generate data from transaction information (e.g., from transaction documents received at the transaction processor 210) that relates to the seller 222's General Ledger chart of accounts using the seller's profile information. The data exchange controller 232 sends the generated data to the seller 222. In some implementations, the data exchange controller 232 sends the generated data to a data processing arrangement that implements the seller 222's General Ledger chart of accounts, with the data being automatically implemented with the General Ledger with appropriate data fields in the General Ledger being automatically posted using update information. With certain applications, the transaction processor 210 controls the seller 222's General Ledger for these purposes, and may implement the General Ledger and associated processing directly (e.g., internally to the transaction processor and storing data at the database 212).

In some implementations, the user-specific data generator 234 is adapted to respond to interaction with users such as a buyer 220 or seller 222 by generating user-specific data relative to the user. For example, where buyer 220 is granted access to the transaction processor 210 using, e.g., authentication data stored in the database 212, the buyer can request data to be generated and/or extracted from the database 212 by the user-specific data generator 234 and communicated to the buyer 220. In some applications, the transaction processor 210 generates a user interface (e.g., a web-based user interface) accessible by the buyer 220 and used to facilitate the above-discussed authentication and data communication.

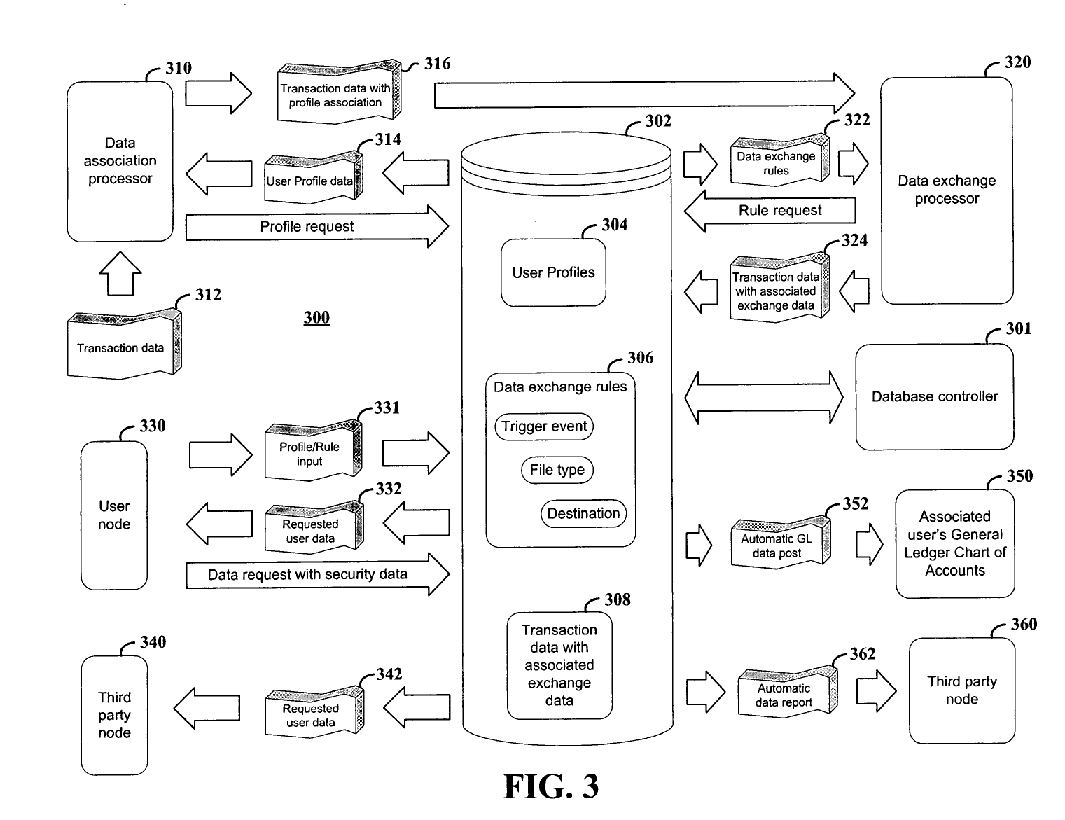

FIG. 3 is a flow diagram showing an arrangement 300 and corresponding approach to managing data exchange in connection with transactions and related data management, according to another example embodiment of the present invention. Functional components include a database 302, a database controller 301, a data exchange processor 320 that controls the exchange of data and interaction with the database 302 and a data association processor 310 that associates incoming transaction data with a particular user or set of users. Users access the arrangement 300 for storing user-specific information to configure user access and data exchange, and for providing transaction information to the arrangement.

The database 302 is adapted to store user profiles 304, data exchange rules 306 and associated transaction data 308. Users interact with the database 302 for providing data stored with the user profiles 304 and data exchange rules 306. In some instances, the user profiles 304 include data exchange rules 306 for each user. Once a profile and a set of data exchange rules are established for a particular user, that user interacts with the database 302 for retrieving stored transaction information. This interaction is active and/or passive (e.g., automatic as specified by each user), depending upon the application, in accordance with the profiles 304 and data exchange rules 306.

The database 302, data exchange processor/database controller 320 and data association processor 310 are implemented in a variety of manners, depending upon the application, the user or users requesting access to data, the type of data and other characteristics specific to each user and related transaction data. In addition, the approach shown here in FIG. 3 is selectively implemented in connection with the transaction processing arrangement 200 shown in FIG. 2 and discussed above. For purposes of discussion, certain example interactive approaches with the arrangement and approach shown in FIG. 3 are shown and described as follows.

As discussed above, each user accessing the arrangement 300 provides information that is stored with the user profiles 304 and data exchange rules 306 to facilitate that user's interaction with the database 302. In this regard, a user at user input node 330 provides profiles and rules 331 as an input to the database 302. The profile information from the user at user node 330 is stored with the user profiles 304, and the user's data exchange rules are stored with the data exchange rules 306 (e.g., in connection with identification data for the user). In this manner, a plurality of such users access the database 302 for storing profile information and data exchange rules, through similar user nodes.

Once a user has its profiles and rules stored in the database 302, and further meets other conditions appropriate for access to the arrangement 300 (e.g., pays fees), the arrangement is ready to process transaction data 312 pertaining to transactions involving the user. In some applications, the transaction data 312 includes a transaction-based document (e.g., an electronic set of data) such as an order, an invoice or a receipt. This data can be sent from a particular user party having its user profile stored with the database 302, or by a party engaging in a transaction with such a user party. In other applications, the transaction data 312 is update data provided by subscribing users having profiles and data in the database 302, and is used for updating appropriate transaction-based data such as an accounting field relating to a particular transaction.

When transaction data 312 is sent to the data association processor 310, a user profile request is sent to the database 302 (e.g., as facilitated by the database controller 320). In response to the request, user profile data 314 that pertains to the request is sent to the data association processor 310, or is otherwise made available for retrieval by the data association processor. The data association processor 310 associates appropriate user profile data with the transaction data 312, and sends the transaction data 316 with an associated user profile to the data exchange processor 320.

When the transaction data 316 is received at the data exchange processor 320, a rule request is made to the database 302, with the request including user profile information that is used to associate the rule request with the appropriate data exchange rules. In this regard, data exchange rules 322 are returned to the data exchange processor 320. The data exchange processor 320 then uses the returned data exchange rules 322, together with information in the transaction data, to associate exchange data with the transaction data. For instance, when a particular set of data exchange rules indicates that a certain type of expense data be reported in a particular manner, the data exchange processor 320 associates appropriate reporting rules with that certain type of expense data, when included with the transaction data 316. In this regard, the data exchange rules can be selectively tailored to particular types of transaction data and assigned thereto, with the transaction data 324. As discussed above, e.g., in connection with FIG. 2, the data exchange processor 320 may associate particular information in the transaction data 316 with an accounting-type of field, and apply data exchange rules based on that accounting-type field.

The transaction data 324 is stored with transaction data 308 and having associated exchange data, such as codes or other information, that identifies particular data exchange rules to follow, as determined via the data exchange processor 320. In some instances, the transaction data is stored with information characterizing the data exchange rules. In other instances, the transaction data is stored with information that can be used by the data exchange processor to associate that stored transaction data with a particular set of data exchange rules. Such a set of rules include rules indicating, for example, a trigger event that initiates a data transfer, a file type that characterizes the type of file to transfer and destination information characterizing the destination of the data.

Once the transaction data 308 is stored, the database controller 301 facilitates the reporting of that data, passively and/or actively. For instance, where a user at user node 330 requests data and provides appropriate security information, requested user data 332 is sent to the user node. Where the user at user node 330 requests that data be provided to a third party node 340, the database sends that requested data 342 to the third party node. Similarly, the user at user node 330 may request that data be sent to that user's associated General Ledger Chart of Accounts 350 in the form of an automatic General Ledger (GL) data post (e.g., with the data being formatted by the database controller 301 in accordance with data exchange rules 306 for the user).

Where passive data exchange functions are set with the data exchange rules 306, data is sent to one or more of the user node 330, the user's General Ledger Chart of Accounts 350, the third party node 360 or other locations, as designated. The automatic exchange may involve the use of a cyclic type of exchange (e.g., monthly), where data is reported on a cycle. Trigger events such as the receipt of an invoice, the confirmation of payment, the update of a particular data field or others may also be used to generate an exchange of data.

The example embodiments, implementations and other approaches shown in the figures and described herein are applicable to a variety of different types of data exchange approaches, involving one or more parties and implemented using one or more of a variety of systems. The following example use-case application is selectively implemented in connection with one or more of these embodiments, implementations and approaches, wherein a buyer company, engaged in retail operations, implements automated data exchange functions. The buyer also implements automated accounting classification and payment, for invoices (and other transaction-related documents) from its vendors selling merchant offerings, in connection with the automated data exchange functions. Furthermore, the following example is selectively implemented with a revenue accounting approach, with similar functions carried out in recording revenue-type accounting recordkeeping.

The buyer implements the automated data exchange system to carry out accounting sub-ledger functions by facilitating and maintaining accounting sub-ledger data in which detailed information is kept. The sub-ledger data underlies expense posting entries to the buyer's general ledger. The automated data exchange system facilitates the presentation of a posting file to the buyer for recordkeeping in connection with its general ledger, which can be implemented on a selected cycle, e.g., at the end of each fiscal period using a 5/4/4 fiscal cycle, fixing each month at a select number of weeks.

The buyer identifies invoices to be extracted and summarized for each general ledger file that is to be provided to the buyer via the automated data exchange system. In this example, the buyer indicates that it wants those invoices that have been paid during the current accounting period to be extracted and summarized in the general ledger file, and that data sent is summarized data. In response, the automated data exchange system generates a posting record for each general ledger accounting code to which expenses are to be posted, with the codes implemented, e.g., in accordance with one or more example embodiments discussed herein and/or with the above-indicated priority document, U.S. Provisional Patent Application No. 60/578,244. The posting record for each general ledger accounting code provides, for each fiscal cycle, the total amount of expense to be recorded for the period with the particular accounting code.

The buyer also identifies when to extract the invoice information identified as discussed above. The automated data exchange system provides one of a number of pre-defined options for extracting information, from which the buyer selects. These options include: daily exchange, weekly exchange specifying the day of week for the exchange, monthly exchange specifying the day of the month (e.g., the last weekday of the month, last calendar day of the month or any specific day within the month), or exchange based upon a user-defined calendar. When using the 5/4/4 retail calendar, the buyer selects a user-defined calendar and enters the specific dates on which files are to be extracted and delivered, corresponding to the specific implementation of the 5/4/4 retail calendar. Dates can be entered as far into the future as the buyer desires.

The buyer also identifies a location or locations to which extracted data is to be sent, with the location information used by the automated data exchange system, e.g., by storing the location information or otherwise accessing the location information as made available via the buyer. For instance, the buyer can enter an electronic address of a desired destination or set of destinations, such as an email address and/or a URL. Where automatic posting is implemented, the buyer enters a destination URL associated with the buyer's electronic processing functions configured for receiving and processing posting data sent by the automated data exchange system.

In connection with the type of system and approach implemented by the buyer, and in some instances for each location specified for delivery by the buyer, the buyer identifies a manner in which to send the extracted data. This identification generally includes information specifying a format of the exchange data and a transmission protocol to use in sending the exchange data. In addition, the format and transmission protocol may also be set as a function of the type of data being exchanged. For instance, for accounting data, the automated data exchange system provides the buyer with format options including those providing a summary by accounting code, and those providing details by accounting code. With this approach, when the buyer does not want to carry all the line item details in its general ledger, the buyer can selects to receive the summary by accounting code. In some implementations, the level of detail carried in the buyer's general ledger is tailored using the selective delivery of data, e.g., to limit the details by posting a summary by accounting code to the general ledger, relative to posting all line item accounting data. In this regard, the relatively summarized nature of the posting facilitates the inhibition of reconciliation problems that can occur in connection with fiscal period close processes, which can speed these processes.

In addition to the above format considerations, the data transfer protocol determines how secure and robust the transmission will be. The automated data exchange system selectively implements specified data transfer protocols such as file transfer protocol (ftp), hypertext transfer protocol secure (HTTPS), and AS2 (Applicability Statement 2). AS2 is a business-to-business document exchange specification developed by the Internet Engineering Task Force (IETF), which describes how current Internet standards can be used to achieve functionality for process-to-process (real-time) EDI (electronic data interchange) based on MIME and HTTP type protocols. AS2 supports object signature security, and both session and object encryption.

The buyer also identifies an action to be taken by the automated data exchange system after data is delivered. Where receipt of the data is to be acknowledged, the buyer identifies a time period during which the automated data exchange system is to wait for an acknowledgement of receipt from the buyer before taking action, as well as selecting the action to be taken when acknowledgement is not received in a timely manner. These actions to be identified by the buyer can include some or all of the following: resending the file; sending an email to a designated party to communicate lack of acknowledgement, and setting an alarm with a user interface generated by the automated data exchange system.

Once a buyer sets of the various conditions as discussed above such that setup activity is complete, the information is used by the automated data exchange system to process data exchange on behalf of the buyer. For example, where the buyer has a buyer profile, the setup information can be stored with the buyer profile and accessed for implementation of data exchange. In addition, once setup activity is completed, the buyer can go into the data characterizing the setup selections (e.g., a data exchange profile for the buyer) and alter the identified setup, either on a global basis (e.g., cyclic) or for a particular instance of data extraction. The buyer selectively makes the altered setup conditions effective as soon as they have been entered or at a specified future effective date. Similarly, the buyer can set an expiration date and time for the setup, or conditions upon which the setup expires.

The automated data exchange system reviews (e.g., continuously or periodically) the buyer's selected exchange condition, for example, by reviewing the buyer's profile to identify data extraction functions that it needs to run. When a pre-selected date as specified above becomes the current date, the automated data exchange system extracts data per rules defined by the buyer for the particular data extraction to be performed, and constructs and delivers a file to a specified destination in the format and using the protocol specified by the buyer. The data exchange system then waits for an acknowledgement from the buyer's receiving computer system; if the acknowledgement is not received within a time frame specified by the buyer, the data exchange system raises appropriate alarms to systems associated therewith and, where specified, to the buyer.

In some applications, the above approach facilitates the implementation of transactions involving the addition of freight charges to the cost of a transaction, wherein the seller of goods bought by a buyer pays the freight cost to transport the goods. The cost of the freight is added to the seller's invoice to the buyer for the goods. This approach involves the specification of information by the buyer (or by the seller in connection with the buyer) for facilitating the transaction, such as by storing appropriate information in the buyer's profile, specifying that a payment made for the transaction is for the goods and the freight associated therewith. The information in the buyer's profile may, for example, include data that is used to process payment for such a freight-included invoice in a manner that facilitates recordkeeping on behalf of the buyer, relative to expense categorization (i.e., to separate the cost of goods from the cost of shipment for a particular invoice). The automated data exchange system handles the transfer of data associated with the transaction accordingly, with information made available to the buyer reflecting the inclusion of freight with the invoice cost of the transaction.

Those of skill in the art will appreciate that the above-discussed approaches may be implemented using a variety of arrangements and processes. For example, the computer-based approaches shown and discussed in U.S. Pat. No. 5,910,896 (USBA.002PA, filed Nov. 12, 1996 and incorporated herein by reference) may be implemented for one or more of the various embodiments discussed herein. In addition, for general information regarding transaction processing, including computer-implemented processing, and for specific information regarding approaches that may be implemented in connection with various example embodiments herein, reference may be made to U.S. patent application Ser. No. 10/436,878 (USBA.101PA), entitled “Automated Transaction Processing System and Approach” and filed May 12, 2003, and to U.S. patent application Ser. No. 09/527,717 (USBA.004PA), entitled “VALIDATION APPROACH FOR AUDITING A VENDOR-BASED TRANSACTION” and filed Mar. 17, 2000, which are fully incorporated herein by reference.

While certain aspects of the present invention have been described with reference to several particular example embodiments, those skilled in the art will recognize that many changes may be made thereto without departing from the spirit and scope of the present invention, aspects of which are set forth in the following claims.

1. A transaction-processing system for processing transaction data for transactions involving merchant offerings among transaction parties, with user profile information for transaction parties including information for associating transaction data with a transaction party and for generating and controlling access to party-specific data, the system comprising:
a computer arrangement adapted, for a particular party to a transaction, to associate transaction data with the particular party as a function of the transaction data and user profile information for the particular party,
generate party-specific data from the transaction data as a function of the particular party's user profile information, and
provide access to the generated party-specific data to the particular party as a function of the user profile information.

2. The system of claim 1, wherein the user profile information for the particular party includes configuration information specifying a configuration format of data for which access is to be provided and wherein the computer arrangement is adapted to generate party-specific data by configuring the selected portion of the transaction data for access by the particular party as a function of the configuration information.

3. The system of claim 1, wherein the user profile information for the particular party includes information specifying a timing condition for use in determining when to generate party-specific data for which access is to be provided and wherein the computer system is adapted to generate party-specific data from the transaction data as a function of the timing condition.

4. The system of claim 3, wherein the information specifying a timing condition is indicative of a trigger event and wherein the computer system is adapted to generate party-specific data in response to the occurrence of the trigger event.

5. The system of claim 3, wherein the information specifying a timing condition specifies a calendar-based time and wherein the computer system is adapted to generate party-specific data at the specified calendar-based time.

6. The system of claim 1, wherein the user profile information for the particular party includes information specifying portions of transaction data for which access is to be provided and wherein the computer arrangement is adapted to generate party-specific data by selecting a portion of the transaction data for which access is to be provided as a function of the specified portions in the user profile information for the particular party.

7. The system of claim 1, wherein the computer arrangement is adapted to generate party-specific data from the transaction data for the particular party as a function of accounting codes associated with the transaction data.

8. The system of claim 7, wherein the user profile information for the particular party includes information for assigning accounting codes to transaction data and wherein the computer arrangement is adapted to associate the accounting codes with the transaction data as a function the user profile information and the transaction data.

9. The system of claim 7, wherein the computer arrangement is adapted to provide access to the generated party-specific data by automatically posting a general ledger (GL) account field for the particular party, using the accounting codes to identify a proper GL account field to be posted.

10. The system of claim 1, wherein the user profile information for the particular party includes data transfer protocol information and wherein the computer arrangement is adapted to provide access to the generated party-specific data to the particular party as a function of the user profile information by transferring the generated party-specific data in accordance with the data transfer protocol.

11. The system of claim 1, wherein the user profile information for the particular party includes communication information identifying a location to which the particular party wants transaction data to be sent and wherein the computer arrangement is adapted to provide access to the generated party-specific data to the particular party as a function of the user profile information by sending the party-specific data to the particular party at the identified location.

12. The system of claim 11, wherein the computer arrangement is adapted to make a record of the transmission of the party-specific data to the particular party.

13. The system of claim 11, wherein the computer arrangement is adapted to receive a receipt from the particular party acknowledging the receipt of the party-specific data and to record data indicating that the receipt was received.

14. The system of claim 1, wherein the user profile information for the particular party includes information specifying a third-party recipient of the generated party-specific data and wherein the computer arrangement is adapted to provide access to the generated party-specific data to the specified third party.

15. The system of claim 1, wherein the computer arrangement is adapted to generate a user interface for presentation to the transaction parties, the user interface adapted to
present information for use in authenticating particular transaction parties via user inputs, and
facilitate access to the generated party-specific data via the interface.

16. The system of claim 15, wherein the user interface is adapted to receive configuration inputs from an authenticated transaction party and wherein the computer arrangement is adapted to update profile information for authenticated transaction party in the databank in response to the configuration inputs.

17. The system of claim 1, wherein the computer arrangement is adapted to controllably manage at least one data storage arrangement to store at least one of the user profiles and the generated party-specific data.

18. The system of claim 17, further comprising the at least one data storage arrangement.

19. The system of claim 1, wherein the user profile information for the particular party includes information for auditing the transaction data and wherein the computer arrangement is adapted to
audit the transaction as a function of the user profile information,
generate party-specific data including results of the audit as a function of the particular party's user profile information, and
provide access to the auditing results to the particular party as a function of the user profile information.

20. For use with a transaction processing system for processing transaction data for transactions involving merchant offerings among transaction parties, a method for facilitating access to selected transaction data, the method comprising:
generating and sending party-specific data to a transaction party as a function of user profile information specifying a type of transaction data, a timing characteristic identifying a time at which to generate the specified type of transaction data, a location to which the generated transaction data is to be sent and a protocol via which the generated transaction data is to be sent.

21. The method of claim 20, further comprising, after generating and sending the party-specific data:
monitoring incoming acknowledgement communications indicative of the transaction party receiving the generated and sent party-specific data,
in response to not receiving acknowledgement of receipt of the party-specific data, generating an exception indication, and
in response to receiving an acknowledgement of receipt of the party-specific data from the transaction party, recording data indicative of the acknowledgement.

22. A method for processing transaction data for transactions involving merchant offerings among transaction parties, with user profile information for transaction parties including information for associating transaction data with a transaction party and for generating and controlling access to party-specific data, the method comprising, for a particular party to a transaction:
associating transaction data with the particular party as a function of the transaction data and user profile information for the particular party;
generating party-specific data from the transaction data as a function of the particular party's user profile information; and
providing access to the generated party-specific data to the particular party as a function of the user profile information.

23. The method of claim 22, further comprising receiving and storing the user profile information for the transaction parties.

24. The method of claim 22, wherein the user profile information includes information for assigning accounting codes to financial data for the particular transaction and wherein generating party-specific data from the transaction data as a function of the particular party's user profile information includes generating party-specific data from the transaction data as a function of the information for assigning accounting codes.

25. The method of claim 24, further comprising assigning an accounting codes to the financial data for the particular transaction.

26. The method of claim 22, further comprising configuring the generated user-specific transaction data for use by the transaction party as a function of the transaction party's stored profile information.

27. The method of claim 26, wherein configuring the generated user-specific transaction data for use by the transaction party as a function of the transaction party's stored profile information includes configuring the user-specific transaction data for posting to a transaction party's general ledger chart of accounts.

28. The method of claim 22, wherein generating party-specific data from the transaction data as a function of the particular party's user profile information includes generating party-specific data from the transaction data as a function of a timing condition specified in the particular party's user profile.

29. The method of claim 28, wherein generating party-specific data from the transaction data as a function of a timing condition specified in the particular party's user profile includes generating user-specific data in response to a trigger event defined by the particular party's user profile information.

30. The method of claim 28, generating party-specific data from the transaction data as a function of a timing condition specified in the particular party's user profile includes generating party-specific data at a calendar-based time specified in the particular party's user profile.

31. The method of claim 22, wherein generating party-specific data from the transaction data as a function of the particular party's user profile information includes generating party-specific data from a selected type of information in the transaction data as a function of information in the particular party's user profile that specifies the type of information.

32. The method of claim 22, wherein providing access to the generated party-specific data to the particular party as a function of the user profile information includes transferring the generated party-specific data in accordance with a data transfer protocol specified in the particular party's user profile.

33. The method of claim 22, wherein providing access to the generated party-specific data to the particular party as a function of the user profile information includes transferring the generated party-specific data to a location specified in the particular party's user profile.

34. The method of claim 33, further comprising recording data indicating the transfer of the generated party-specific data.
